(19) United States
(12) Patent Application Publication
(10) Pub. No.: US 2023/0008184 A1
(43) Pub. Date: Jan. 12, 2023

(54) METHOD FOR CONTROLLING AN ELECTRIC MOTOR FOR A PUSH-ASSISTANCE OPERATING MODE, CONTROL DEVICE, AND BICYCLE

(71) Applicant: Robert Bosch GmbH, Stuttgart (DE)

(72) Inventor: Daniel Baumgaertner, Tuebingen (DE)

(21) Appl. No.: 17/801,365

(22) PCT Filed: Feb. 16, 2021
(86) PCT No.: PCT/EP2021/053771

§ 371 Date: Aug. 22, 2022

(30) Foreign Application Priority Data
Mar. 2, 2020 (DE) 10 2020 202 621.1
Feb. 3, 2021 (DE) 10 2021 200 971.9

(51) Int. Cl. B62M 6/50; B62J 50/22; B62J 45/412; B62J 45/414; B62J 45/413

(52) U.S. Cl. CPC B62M 6/50; B62J 50/22; B62J 45/412; B62J 45/414; B62J 45/413

(57) ABSTRACT

A method for controlling an electric motor as a drive motor of a bicycle. The method includes: a sensor-based detection of pushing of the bicycle by the user; acquiring an input of a user for activating the push-assistance operating mode, the acquisition taking place as a function of the detected pushing of the bicycle; and generating a motor torque for driving the bicycle in the push-assistance operating mode as a function of the detected pushing and the acquired input of the user.

### FIELD

The invention relates to a method for controlling an electric motor as a drive motor of a bicycle for a push-assistance operating mode. In addition, the invention relates to a control device, which is designed to carry out the method according to the present invention, and to a bicycle having this control device.

### BACKGROUND INFORMATION

Bicycles equipped with an electric motor as a drive motor, in particular electric bicycles, are available in the related art. During a normal operation, the control of the electric motor preferably takes place as a function of a detected pedaling force of a bicyclist on the pedals of the bicycle or electric bicycle, for which purpose a driver torque is acquired with the aid of sensors. In addition, a push-assistance operating mode for pushing the bicycle to supplement the force of the bicyclist when pushing the bicycle is described in the related art. The push-assistance operating mode, also abbreviated to push assist, has since become an important function of the usually quite heavy bicycles because pushing can be difficult, in particular on uphill stretches of the driving route. In the push-assistance operating mode, a motor assists the bicyclist walking next to the bicycle up to a relatively low speed. In other words, the bicyclist does not apply any pedal force on the pedals during the force assistance rendered by the generated motor torque in the push-assistance operating mode. Due to the two-step enabling in the push-assistance operating mode, e.g., by two keys being pressed, an accidental activation of the push-assistance mode such as by a faulty operation on a steep stairway or while repair work takes place is able to be avoided. However, the double detection of an input for activating the push-assistance operating mode is not particularly intuitive so that some users do not know how to activate the push-assistance operating mode.

German Patent Application No. DE 10 2016 218 374 B3 describes a control method for generating a torque with the aid of an electric motor for driving an electric bicycle given an activated push assistance.

German Patent Application No. DE 10 2016 209 570 B3 describes a control method for push assistance of an electric bicycle.

German Patent Application No. DE 10 2016 209 560 B3 describes a control method for controlling an electric motor for a push assistance for an electric bicycle. The control method controls the electric motor as a function of an acquired pitch angle of the electric bicycle abouts its transverse axis.

It is an object of the present invention to simplify an activation of the push-assistance operating mode for a bicyclist or user.

### SUMMARY

According to the present invention, the above object may be achieved according to the present invention.

The present invention relates to a method for controlling an electric motor as a drive motor of a bicycle. The bicycle is an electric bicycle, in particular. According to an example embodiment of the present invention, the control method includes as method steps a sensor-based detection of the pushing of a bicycle or a detection of the pushing of the bicycle by a user, with the aid of a sensor or a sensor unit, which preferably includes an acceleration sensor. In other words, it is advantageously recognized when the user is pushing the bicycle while walking. In addition, a pushing direction of the pushing of the bicycle by the user is optionally detected. The pushing detection is advantageously carried out based on sensors so that an automatic pushing detection is provided. In a further step of the present method, an input of the user for activating a push-assistance operating mode is acquired, in particular with the aid of an input means such as a switch, key, touchscreen or push button. More specifically, the input is acquired only if a continual input or a continual operation of the input means is present. For instance, a continuous input at an input means or an operation of the input means is identified or acquired as soon as the input lasts for more than or is equal to a predefined time period, this time period amounting to between 1 and 10 seconds, for example. In an advantageous manner, the acquisition of the user input takes place as a function of the detected pushing or during pushing. In other words, in this optional embodiment, the detected pushing of the bicycle advantageously enables or allows the acquisition of the user input for activating the push-assistance operating mode. As an alternative, the detection of pushing advantageously occurs after the input of the user is acquired, the detection of pushing advantageously being carried out as a function of the acquired input. In other words, in this optional embodiment, the detection of the pushing is enabled or allowed by the acquired user input. Next, a motor torque for driving the bicycle is generated as a function of the acquired input for activating the push-assistance operating mode and as a function of the detected pushing. In other words, a motor torque for a push assistance is advantageously generated, or the push assistance is activated by the acquired input of the user for activating the push-assistance operating mode during a sensor-based detection of pushing. In an advantageous manner, the generated motor torque may be configured for driving the bicycle forward or backward in the driving direction as a function of a detected pushing direction. In addition, the motor torque is advantageously generated as a function of the detected pushing. For example, the generation of the motor torque is thereby activated when an input by the user was previously acquired. As a result, for example, the generation of the motor torque is additionally or alternatively aborted if no further pushing of the bicycle is detected or if the bicycle is actively braked by the driver, and/or a speed of the bicycle is optionally adapted as a function of an acquired pushing speed of the detected pushing. The method provides the advantage that a single acquired input by the bicyclist or user is sufficient to activate the push-assistance operating mode or to generate a motor torque that assists in the pushing operation, while it is impossible to accidentally activate the push assistance in the process. In an advantageous manner, a deactivation of the push-assistance operating mode is furthermore easy to achieve insofar as the input of the user is acquired only in a continuous operation of the input means, for example. The control method thus allows for an easy and intuitive operation, in which a faulty activation of the push-assistance operating mode is virtually impossible because of the automated detection of the pushing of the bicycle by the user or bicyclist as a necessary condition for generating the motor torque or for activating the push-assistance operating mode. In other words, the control method advantageously represents a two-step activation of a push-assistance operating mode for generating the motor torque through the detection of pushing as one step and the acquisition of the input of the user as another step. It is particularly provided to activate the push-assistance operating mode to generate the motor torque by the acquisition the user input and the subsequent detection of the pushing, whereby the motor torque for driving the bicycle or the electric bicycle is generated, the generation of the motor torque in particular requiring a continuous acquisition of the input of the user for generating the motor torque. As an alternative, it is provided to activate the push-assistance operating mode to generate the motor torque by detecting the pushing and subsequently or simultaneously acquiring the input by the user, which then causes the motor torque for driving the bicycle or electric bicycle to be generated, the generation of the motor torque in particular requiring a continuous acquisition of the user input. Especially preferably, the pushing is detected with the aid of a sensor unit and with the aid of a control device of a drive unit of the bicycle, and the input of the user is acquired with the aid of the input means or push button on a control device on a handlebar of the bicycle and/or with the aid of a display device on a handlebar of the bicycle, thereby providing the advantage that no motor torque for the push-assistance operating mode is generated even if one of these components of the bicycle is malfunctioning. This advantageously increases the safety of the user of the bicycle.

In one preferred example embodiment of the present invention, information relating to enabling the acquisition of the input for activating the push-assistance operating mode is displayed to the user as a function of the detected pushing or while pushing takes place. In other words, after pushing is detected, it is indicated to the user that the push-assistance operating mode is able to be activated as soon as or when an input of the user is detected, the input having to be continuous, in particular. The display of the information advantageously takes place using a display of a display device, which, for instance, is disposed on the handlebar of the bicycle, in particular using a human-machine interface (HMI). As an alternative or in addition, the display of the information may be realized with the aid of lamps, which are situated on or in the handlebar and/or on or in the frame of the bicycle, and/or on or in a push button for activating the push assistance, for example, the lamps including light diodes, in particular. As an alternative or in addition, the display of the information may be in the form of an acoustic signal and/or be implemented with the aid of at least one actuator, the actuator being designed to generate a haptic signal or a vibration of the handlebar and/or the frame of the bicycle. Through this embodiment, the user is informed, and an operation or activation of the push-assistance operating mode takes place in an intuitive manner.

In another particularly preferred example embodiment of the present invention, information for enabling the detection of pushing of the bicycle is displayed to the user as a function of the acquired input by the user for activating the push-assistance operating mode, it particularly being indicated to the user that, after the user input is acquired, the motor torque is generated by a subsequent sensor-based detection of pushing of bicycle, or the push-assistance operating mode is activated by the sensor-based detection of pushing. In other words, after the acquired input, it is displayed to the user that the push-assistance operating mode will be activated as soon as or when pushing of the bicycle is detected, the acquired input in particular having to be continuous. The display of the information is advantageously realized with the aid of the display of the display device, which is situated on the handlebar of the bicycle, for example, especially using a human-machine interface (HMI). As an alternative or in addition, the display of the information may be implemented with the aid of lamps, which are disposed on or in the handlebars and/or on or in the frame of the bicycle and/or on or in a push button for acting the push assistance, for example, the lamps particularly including light diodes.

As an alternative or in addition, the display of the information may be implemented in the form of an acoustic signal and/or with the aid of at least one actuator, the actuator being designed to generate a haptic signal or a vibration of the handlebar and/or the frame of the bicycle. This embodiment likewise informs the user, and an operation or activation of the push-assistance operating mode takes place in an intuitive manner.

In one preferred example embodiment of the present invention, a speed of the bicycle is acquired in a step prior to the pushing detection. Next, the detection of pushing takes place as a function of the acquired speed, in which pushing is particularly detected only at an acquired speed that is less than or equal to a maximum speed of 6 km/h, for example. In this embodiment, a faulty activation of the push-assistance operating mode while the bicycle is ridden during a normal operation is avoided in most driving states.

In one preferred example embodiment of the present invention, an acceleration of the bicycle in the direction of a longitudinal axis of the bicycle and/or in the direction of a transverse axis of the bicycle is acquired. Next, the pushing is detected as a function of the acquired acceleration of the bicycle. In addition, the pushing direction is optionally detected as a function of the acquired acceleration of the bicycle. This embodiment provides the advantage that a movement of the bicycle is already detectable during a standstill or at very low accelerations and/or speeds. The detection of pushing as a function of the acquired acceleration is preferably carried out when a threshold value is exceeded, in particular after filtering of a signal from a sensor unit that represents the acceleration, and/or it is carried out using a machine-trained detection method or artificial intelligence or a trained neural network. For example, this makes it possible to distinguish an acceleration characteristic of a travel of the bicycle at low speeds, e.g., on an uphill slope of the driving route, from an acceleration characteristic while the bicycle is being pushed, so that pushing is detected in an automated and reliable manner.

In one especially preferred example embodiment of the present invention, once the acceleration has been acquired, at least one statistical variable is ascertained as a function of the acquired acceleration in the direction of the longitudinal axis of the bicycle and/or in the direction of the transverse axis of the bicycle, or a characteristic of the acquired acceleration is ascertained. For example, the standard deviation, the average, a variance or a covariance between two acquired acceleration characteristics is ascertained as a statistical variable. The statistical variable, e.g., the standard deviation, is advantageously ascertained for a predefined time span, the time span amounting to between 1 and 10 seconds, for instance. Next in this embodiment, the pushing is also detected as a function of the at least one ascertained statistical variable, e.g., the standard deviation, and a threshold value. The pushing is particularly detected when the ascertained standard deviation during the predefined time span exceeds the threshold value. This embodiment provides the advantage that even small or few movements of the bicycle are able to be detected as pushing.

In a further example embodiment of the present invention, it may be provided to carry out a detection of a change in direction of the acquired acceleration in the direction of the transverse axis within a predefined time span. Next in this embodiment, the detection of pushing is additionally realized as a function of the detected change in direction of the acquired acceleration in the direction of the transverse axis. This embodiment provides the advantage that the user is able to carry out a movement pattern that is easy to remember and intuitive for the detection of the pushing or a pushing desire.

In another example embodiment of the present invention, a rotation of the rotor of the electric motor for a backward-directed movement of the bicycle along the longitudinal axis of the bicycle is acquired. Thereafter, the pushing is detected as a function of the acquired rotor rotation. In particular, the detection of the pushing direction as a function of the acquired rotor rotation takes place as well. This provides the advantage that in typical drive devices that feature motor coasting in a forward-pointing direction of rotation, a movement of the bicycle can be acquired very rapidly and identified or interpreted as pushing.

In one step, it may furthermore be provided to acquire a camera image or a sequence of camera images of at least a portion of an environment of the bicycle. In an advantageous manner, the camera may be positioned on a component of the bicycle, e.g., on a handlebar of the bicycle, with a viewing direction in the driving direction or along the longitudinal axis of the bicycle toward the front. Next, the pushing and/or the pushing direction are detected as a function of the acquired camera image or the sequence of camera images. For example, it may be provided to detect the pushing based on a movement of the bicycle as a function of the ascertained optical flow. The optical flow is able to be ascertained as a function of the sequence of camera images. This embodiment advantageously makes it possible to detect pushing of the bicycle by the user in a relatively reliable and rapid manner.

In a further example embodiment of the present invention, it may furthermore be provided to acquire a force of the user or bicyclist in the direction of the longitudinal axis of the bicycle on a handlebar of the bicycle. In this embodiment, the pushing and/or the pushing direction is/are subsequently detected as a function of the acquired force of the user. This embodiment makes it possible to detect desired pushing of the bicycle and/or a pushing direction in a very reliable manner.

In a further step of the present method, a acquisition of a pedaling variable of the user, in particular an acquisition of a cadence and/or an acquisition of a driver torque, is additionally able to be carried out. Next, the detection of pushing takes place as a function of the acquired pedaling variable of the user, and if a pedaling variable is acquired, no pushing is detected, in particular. This embodiment reliably avoids a faulty activation of the pushing assistance or the push-assistance operating mode.

The display of the information for the possible activation of the push-assistance operating mode is preferably implemented by adapting the illumination of a key for an input of the user to activate the push-assistance operating mode. The key advantageously lights up or blinks in a color-coded manner, in particular in green, when pushing is detected. This embodiment makes it possible to easily display the detected push-assistance wish to the user or bicyclist.

The present invention also relates to a control device. The control device is configured in such a way that it carries out the method according to the present invention. In other words, the control device is designed to carry out the method according to the present invention.

In addition, the present invention relates to a bicycle equipped with a control device according to the present invention.

Additional advantages result from the following description of exemplary embodiments of the present invention with reference to the figures.

### DETAILED DESCRIPTION OF EXAMPLE EMBODIMENTS

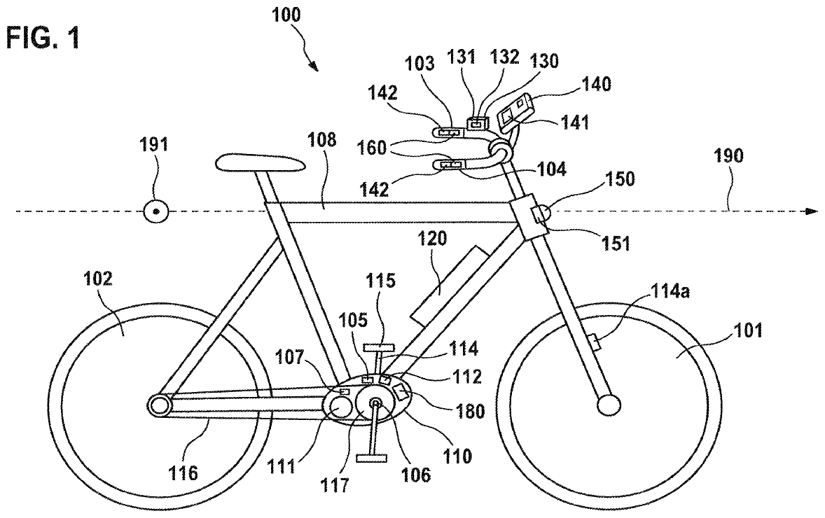

FIG. 1 shows an electric bicycle as a bicycle, according of an example embodiment of the present invention.

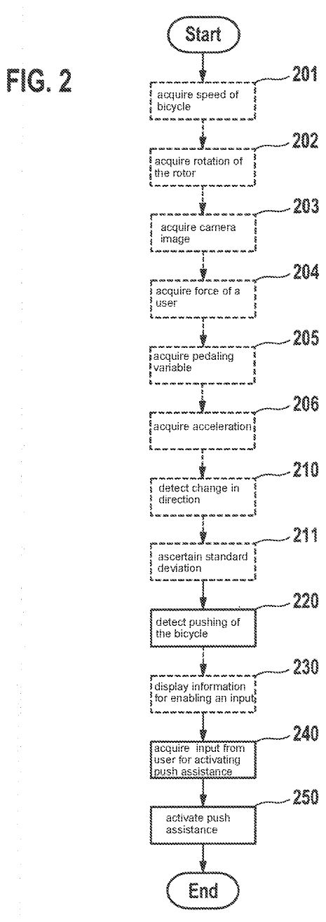

FIG. 2 shows a flow diagram of the method as a circuit diagram, according to an example embodiment of the present invention.

### DETAILED DESCRIPTION OF EXAMPLE EMBODIMENTS

FIG. 1 schematically shows an electric bicycle as a bicycle 100. Alternatively, bicycle 100 could be a motorcycle, the motorcycle being driven with the aid of an electric motor 111. The electric bicycle or bicycle 100 in FIG. 1 has a front wheel 101 and a rear wheel 102 as wheels. Bicycle 100 in FIG. 1 includes a drive unit 110 on a pedal axle 106 or crankshaft, which has an electric motor 111 as a drive motor. Drive unit 110 includes a control device 180, the control device 180 being configured so that it actuates electric motor 111 to generate a motor torque for driving bicycle 100 or electric bicycle. In other words, control device 180 is designed to actuate electric motor 111 to generate a motor torque for driving bicycle 100. With the aid of cranks 114, pedals 115 are connected to pedal axle 106 or the crankshaft for the generation of a driver torque by the driver. The driver torque is able to be acquired as a pedaling variable with the aid of an rpm sensor 105 in the region of pedal axle 106. As an alternative, the pedaling frequency or a cadence may be detected as the pedaling variable of the user, e.g., with the aid of an rpm sensor on pedal axle 106 and/or on pedals 115. Pedal axle 106 or the crankshaft and electric motor 111 are connected to an output pinion 117 with the aid of a gear unit. Output pinion 117, for example, is connected by a connection element 116 such as a chain or a belt to a hub of rear wheel 102 as a drive wheel for driving bicycle 100. It may be provided to position at least one rpm sensor 107 on or in electric motor 111 and/or on the gear unit of drive unit 110 and/or on output pinion 117 and/or on connection element 116 and/or on rear wheel 102 and/or on front wheel 101. In other words, rpm sensor 107 is designed to acquire a rotational speed of a component of the drive train of bicycle 100 or a speed of bicycle 100, especially the rotation or the rotational speed and/or a direction of rotation of electric motor 111 of drive unit 110. In addition, the vehicle has at least one speed sensor 114a and/or 114b and/or 114c. Speed sensor 114a, 114b and/or 114c, for instance, includes a reed sensor 114 on front wheel 101 or rear wheel 102, an rpm sensor 114c, a satellite-based position sensor 114b and/or a radar sensor. Speed sensor 114a, 114b, 114c is designed to acquire the speed of bicycle 100. Speed sensor 114c is preferably situated on a wheel hub of rear wheel 102 and/or on a wheel hub of front wheel 101. Speed sensor 114c is preferably, but not necessarily, rpm sensor 107. A battery module 120 is situated on bicycle 100 for the energy supply of drive unit 110, in particular for the energy supply of electric motor 111. In addition, drive unit 110 includes an inertial measuring unit or a sensor unit 112 or sensor. Sensor unit 112 has at least one acceleration sensor. In an advantageous manner, sensor unit 112 includes an acceleration sensor for acquiring an acceleration in the direction of longitudinal axis 190 of bicycle 100 and an acceleration sensor for acquiring an acceleration in the direction of transverse axis 191 of bicycle 100. Mounted on handlebar 103 of bicycle 100 or the electric bicycle is also an input means or a push button 130 or a switch for activating and/or deactivating a push-assistance operating mode. Push button 130 may have a transparent subregion 131 and an illumination means 132, illumination means 132 in particular being disposed behind transparent subregion 131 and having a green light diode, for instance. In addition, bicycle 100 has a display device 140 including a display 141. Display device 140 is particularly situated on handlebar 103 of bicycle 100. Display 141 is designed to display information to the user or bicyclist. As an alternative or in addition to display device 140, at least one actuator 142, e.g., a vibration motor or an electric motor having a rotating unbalance, is disposed on handlebar 103. Actuator 142 situated on handlebar 103 is advantageously designed to generate a haptic signal for the user at at least one handlebar grip 104 of handlebar 103. It may furthermore be provided to position a force sensor 160 on handlebar 103. Force sensor 160 is designed to acquire a force of the user on handlebar 103 in the longitudinal direction. In addition, the bicycle includes an optional camera unit 150, which, for instance, is situated on handlebar 103 or on frame 108 of bicycle 100, camera unit 150 advantageously having a viewing direction of camera 151 facing forward in the longitudinal direction. Camera 151 is designed to acquire at least a portion of an environment of bicycle 100 as a camera image.

FIG. 2 schematically shows a flow diagram of the present method in the form of a circuit diagram. In an optional step 201, a speed of the bicycle is acquired. In a further, optional step 202, a rotation of the rotor of the electric motor of the bicycle may be acquired, in particular if the rotation of the rotor represents a backward-directed movement of bicycle 100 in the longitudinal direction. As an alternative or in addition, a camera image of at least a portion of an environment of the bicycle is acquired in optional step 203. Moreover, in step 204, it may optionally be provided to acquire a force of the user in the direction of the longitudinal axis of bicycle 100 on the handlebar of the bicycle. In addition, an acquisition 205 of the pedaling variable of the user, in particular the cadence and/or the driver torque, is optionally implemented. In optional step 206, the acceleration of the bicycle in the direction of the longitudinal axis of the bicycle and/or in the direction of the transverse axis of the bicycle is/are acquired. In a subsequent optional step 210, it may be provided to detect a change in direction of the acquired acceleration in the direction of the transverse axis within a predefined time span. As an alternative or in addition, it may optionally be provided in step 211 to ascertain a standard deviation as a function of the acquired acceleration in the direction of the longitudinal axis of the bicycle and/or in the direction of the transverse axis of the bicycle. In step 220, pushing of the bicycle by the user is detected with the aid of a sensor or sensor unit 112. This sensor-based detection 220 of pushing is realized as a function of the acquired speed, for example. As an alternative or in addition, a sensor-based detection 220 of pushing preferably takes place as a function of the acquired speed, the acquired rotor rotation, the acquired camera image, the acquired force of the user and/or the acquired pedaling variable of the user and/or the acquired acceleration in the direction of the longitudinal axis and/or the transverse axis. For example, at a speed that is lower than or equal to a threshold value of 6 km/h, pushing is detected in step 220 or in case of a pedaling variable that is acquired in addition to the speed of less than or equal to 6 km/h, no pushing is detected, in particular. As an alternative or in addition, the sensor-based detection 220 of pushing preferably takes place as a function of the acquired acceleration of the bicycle. It is particularly provided to detect the pushing in step 220 furthermore as a function of the ascertained standard deviation for the acquired acceleration and a threshold value for the standard deviation, the pushing in particular being detected when the ascertained standard deviation exceeds the threshold value. As an alternative or in addition, it may be provided to carry out the sensor-based detection 220 of pushing also as a function of the detected change in direction of the acquired acceleration in the direction of the transverse axis. Particularly preferably, the sensor-based detection of pushing in step 220 is performed as a function of a plurality of acquired variables, e.g., as a function of the speed and the acceleration. Next, in optional step 230, information for enabling an input for activating the push-assistance operating mode is displayed as a function of the detected pushing. Optional display 230 is preferably implemented with the aid of a display unit 140 or a display 141, with the aid of a haptic signal, which is generated by an actuator 142, and/or by adapting an illumination of a key for detecting an input of the user for activating the push-assistance operating mode. In step 240, an acquisition 240 of the input of the user for activating the push-assistance operating mode is carried out, e.g., with the aid of the input means or with the aid of push button 130. The input of the user is optionally acquired only if the operation of the input means or push button takes place continuously. This acquisition 240 may advantageously be performed as a function of the detected pushing. In other words, the input of the user in step 240 is advantageously acquired or considered only if pushing of the bicycle was previously detected in step 240. As an alternative, in step 240, the acquisition 240 of the user input for activating the push-assistance operating mode initially takes place only if the input of the user was continuously detected or if the input means is operated continuously. In this alternative, after the input of the user has been detected, the detection of pushing of the bicycle by the user is detected in step 220 with the aid of a sensor or sensor unit 112 as a function of the acquired user input. In other words, the order is reversed in this alternative embodiment, i.e., the input of the user for activating the push-assistance operating mode is a condition for the sensor-based detection of the pushing of the bicycle in this alternative. It may advantageously be provided that information is displayed to the user after the detected input, the information including a reference for the user that the user is activating the push assistance by pushing the bicycle, which causes a motor torque to be generated. In step 250, a motor torque for driving the bicycle is generated as a function of an acquired input of a user and as a function of the detected pushing. Thus, step 250 activates the push assistance or generates a motoric force or motor torque to assist the user or bicyclist in pushing the bicycle. It may be provided that the motor torque is additionally implemented as a function of the detection 220 of the pushing of the bicycle. It is particularly provided to abort step 250 as soon as no further pushing of the bicycle is detected. In other words, it may particularly be provided to carry out the present method repeatedly and/or continuously.

1-14. (canceled)

15. A method for controlling an electric motor as a drive motor of a bicycle, the method comprising the following method steps:
sensor-based detecting of pushing of the bicycle;
acquiring an input of a user for activating a push-assistance operating mode; and
generating a motor torque for driving the bicycle in the push-assistance operating mode as a function of the detected pushing and the acquired input of the user.

16. The method as recited in claim 15, wherein the following step is carried out prior to generating the motor torque:
displaying information for enabling the acquisition of the input as a function of the detected pushing for activating the push-assistance operating mode.

17. The method as recited in claim 15, wherein the following step is carried out prior to generating the motor torque:
displaying information for enabling the sensor-based detection of pushing as a function of the acquired input of the user for activating the push-assistance operating mode.

18. The method as recited in claim 15, wherein the following steps are carried out prior to acquiring the input of the user:
acquiring a speed of the bicycle; and
detecting the pushing as a function of the acquired speed.

19. The method as recited in claim 15, wherein the following steps are carried out prior to acquiring the input of the user:
acquiring an acceleration of the bicycle in a direction of a longitudinal axis of the bicycle and/or in a direction of a transverse axis of the bicycle; and
detecting the pushing as a function of the acquired acceleration of the bicycle.

20. The method as recited in claim 19, further comprising:
ascertaining a statistical variable as a function of the acquired acceleration in the direction of the longitudinal axis of the bicycle and/or in the direction of the transverse axis of the bicycle; and
detecting the pushing additionally as a function of the ascertained statistical variable and a threshold value, the pushing being detected when the ascertained statistical variable exceeds the threshold value.

21. The method as recited in claim 20, wherein the statistical variable is a standard deviation.

22. The method as recited in claim 19, further comprising:
detecting a change in direction of the acquired acceleration in the direction of the transverse axis within a predefined time span, and
detecting the pushing additionally as a function of the detected change in direction of the acquired acceleration in the direction of the transverse axis.

23. The method as recited in claim 15, further comprising:
acquiring a rotation of a rotor of the electric motor; and
detecting the pushing as a function of the acquired rotor rotation.

24. The method as recited in claim 15, further comprising:
acquiring a camera image of at least a portion of an environment of the bicycle; and
detecting the pushing as a function of the acquired camera image.

25. The method as recited in claim 15, further comprising:
acquiring a force of the user in a direction of a longitudinal axis of the bicycle on a handlebar of the bicycle; and
detecting the pushing as a function of the acquired force of the user.

26. The method as recited in claim 15, further comprising:
acquiring a pedaling variable of the user, in particular a cadence and/or a driver torque; and
detecting the pushing as a function of the acquired pedaling variable of the user, and in the case of an acquired pedaling variable, no pushing is detected.

27. The method as recited in claim 15, wherein the display of the information takes place by adapting an illumination of a key for the input of the user for activating the push-assistance operating mode.

28. A control device configured to control an electric motor as a drive motor of a bicycle, the control device configured to:
sensor-based detect pushing of the bicycle;
acquire an input of a user for activating a push-assistance operating mode; and
generate a motor torque for driving the bicycle in the push-assistance operating mode as a function of the detected pushing and the acquired input of the user.

29. An electric bicycle, having a control device, the control device configured to control an electric motor as a drive motor of a bicycle, the control device configured to:
sensor-based detect pushing of the bicycle;
acquire an input of a user for activating a push-assistance operating mode; and
generate a motor torque for driving the bicycle in the push-assistance operating mode as a function of the detected pushing and the acquired input of the user.
